(19) United States
(12) Patent Application Publication
(10) Pub. No.: US 2006/0074725 A1
(43) Pub. Date: Apr. 6, 2006

(54) Method and apparatus for simulating implementation models of business solutions

(75) Inventors: Ying Huang, Yorktown Heights, NY (US); Makoto Kano, Yokohama-shi (JP); Akio Koide, Yokohama-shi (JP); Bala Ramachandran, Harrison, NY (US); Frederick Yung-Fung Wu, Cos Cob, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/952,935

(22) Filed: Sep. 30, 2004

(51) Int. Cl. G06F 9/44

(52) U.S. Cl. 705/7

(57) ABSTRACT

A method (and system) for simulating an implementation model of a business solution includes simulating business artifacts that invoke the implementation model of the business solution, at least one of simulating and executing a component of the business solution during at least one intermediate stage of a development and integration lifecycle of the implementation model, and analyzing results from the simulation of the implementation model during said at least one intermediate stage of the development and integration lifecycle of the implementation model, thereby allowing a user to simulate an implementation model using both real solution components and simulated solution components.

### BACKGROUND OF THE INVENTION

1. Field of the Invention

The present invention generally relates to a method and apparatus for analyzing implementation models of business solutions, and more particularly to a method and apparatus for simulating and analyzing implementation models at any stage during the development and integration lifecycle of the implementation model. Such an implementation model analysis method uses both real and simulated solution components to analyze the implementation model at intermediate stages.

2. Description of the Related Art

In general, development of business integration solutions is a time-consuming and costly activity. A prime contributor to such problems is the multiple iterations that are involved in the design, development and deployment of any integration solution, due to functional and nonfunctional defects found in the process. In general, earlier detection of defects drives cost reduction and also impacts the time taken to complete the integration solution. Thus, it is desirable to detect any existing process defects as early as possible.

Simulation of business process models is a key technology used to identify process-logic defects during the design-time of business integration solutions. Simulation of business process models can be done at both the business and information technology (IT) levels. At the business level, business process simulation enables the analysis of “what-if” scenarios to test the operational process design and identify any process-logic defects in the operational process level. This analysis occurs at the design stage of the business solution. In these simulators, all of the solution components are simulated (see Law & Kelton, “Simulation Modeling and Analysis”, McGrawHill Publications, 2000 and Laguna & Marklund, “Business Process Modeling, Simulation and Design”, Pearson Prentice Hall Publications, 2004). There are several simulators available commercially, applicable both at the business level (see for example http://www.arena.com) and at the IT level (see for example http://www.hyperformix.com).

The next phase of analysis occurs after the business solution is developed and may undergo several stages from unit testing to system integration testing. This analysis occurs during the integration or deployment stage of the business solution. Here, clients may be simulated, but all solution components are real. Several commercial tools support the simulation of this stage, too (see for example, http://www.mercuryinteractive.com).

However, prior to the present invention, there has been no testing conducted for the whole implementation model between the design stage and the integration or deployment stage of the business solution. It would be desirable to analyze the business solution during intermediate stages of the development and integration lifecycle, when the implementation models are actually being developed, so that defects are detected as early as possible and do not propagate further in the lifecycle. At these intermediate stages, some solution components may be real and some may need to be simulated. Currently, the conventional methods and systems do not provide an implementation model using both real and simulated components.

That is, a system integration test and a performance test can be executed only after all solution components are set up. Therefore, several functional defects due to connectivity/dependency between components, and performance issues are undetectable during the intermediate stages of the development and integration lifecycle.

Thus, conventional simulation approaches for simulating implementation models for business solutions do not allow analysis using both real and simulated components. Additionally, conventional approaches do not allow analysis of a business solution at an intermediate stage during the development and integration lifecycle of the business solution.

### SUMMARY OF THE INVENTION

In view of the foregoing and other exemplary problems, disadvantages, and drawbacks of the conventional implementation models, it is an exemplary feature of the present invention to provide a method (and system) for simulating and analyzing an implementation model of a business solution at any stage during the development and integration lifecycle of the implementation model.

In a first aspect of the present invention, a method (and system) for simulating an implementation model of a business solution, including simulating the business artifacts that invoke the implementation model of the business solution, at least one of simulating and executing a component of the business solution during at least one intermediate stage of the development and integration lifecycle of the implementation model, and analyzing results from the simulation of the implementation model during the at least one intermediate stage for the development and integration lifecycle of the implementation model.

In a second aspect of the present invention, a computer system for simulating implementation models of a business solution, includes means for implementing and analyzing the implementation model during at least one intermediate stage of a development and integration lifecycle of the implementation model, and means for communicating to a user a result output of the implementing and analyzing of the implementation model.

In a third aspect of the present invention, a signal-bearing medium tangibly embodying a program of machine readable instructions executable by a digital processing apparatus to perform a method for analyzing implementation models of a business solution, includes implementing and analyzing the implementation model during at least one intermediate stage of a development and integration lifecycle of the implementation model.

In a fourth aspect of the present invention, a method for deploying computing infrastructure, includes integrating computer readable code into a computing system, wherein the code in combination with the computing system is capable of performing a method for analyzing implementation models of a business solution, wherein the method for analyzing implementation models of a business solution includes implementing and analyzing the implementation model during at least one intermediate stage of a development and integration lifecycle of the implementation model.

In a fifth aspect of the present invention, an apparatus for simulating implementation models of a business solution, includes a traffic generator for generating a client order, a simulation manager for modeling a behavior of a solution component and storing the behavior of the solution component in a configuration file and a connector configuration that switches between a real solution component and a simulated solution component based on an instruction from the configuration file. Furthermore, the simulation manager manages the simulation execution including components such as queue management, statistics gathering, and output reporting.

Unlike conventional implementation model simulators discussed above, the present invention allows a user to analyze a business solution while the business solution is being developed. The implementation model of the business solution may be analyzed at any stage during the development and integration lifecycle so that functional and nonfunctional defects may be detected and prevented from propagating through the entire lifecycle. The present invention provides the capability to simulate and analyze implementation models using real solution components and simulated solution components.

Thus, the present invention enables the analysis of business processes during the development and deployment phases of the business process management lifecycle. At this stage, some activities can involve the invocation of procedures in applications, while other activities are simulated. Simulation of such implementation models (also referred to as “Platform Specific Models”) can be useful for identifying solution defects at an early stage in the lifecycle, by enabling functional testing of the solution artifacts that have been created and performance testing for the entire business solution. Moreover, it makes it possible to incrementally test and develop the system.

Thus, the exemplary method and apparatus for simulating implementation models of business solutions of the present invention identifies functional and nonfunctional defects at intermediate stages during the development and integration lifecycle to prevent the defects from propagating through the entire lifecycle. Identification of defects during the intermediate stages of the development and integration lifecycle will reduce the cost associated with the development of business integration solutions by minimizing the number of iterations that are involved in the design, development and deployment of the business solution. In addition, the time required for deploying a business process may be reduced.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is a flow diagram showing an architecture of an implementation model simulation 10 according to an exemplary method of the present invention;

FIG. 2 is a flow diagram illustrating a role of a connector configuration 70 in the exemplary implementation model simulation according to the present invention;

FIG. 3 is a schematic diagram illustrating exemplary code for a common operation interface of the exemplary implementaton model simulation according to the present invention;

FIG. 4 is a schematic diagram illustrating a schema of a connector configuration file of the exemplary implementaton model simulation according to the present invention;

FIGS. 5A and 5B are schematic diagrams illustrating a schema of a configuration file for generating traffic data of the exemplary implementaton model simulation according to the present invention;

FIG. 6 is a diagram illustrating sample simulation input data 90;

FIG. 7 is a schematic diagram illustrating a schema of a configuration file for a resource model of the exemplary implementaton model simulation according to the present invention;

FIGS. 8A and 8B are schematic diagrams illustrating a schema of a configuration file for a task model of the exemplary implementaton model simulation according to the present invention;

FIGS. 9A-9D are timeline diagrams illustrating a fast forward synchronizing method of the exemplary implementation model simulation according to the present invention;

FIG. 10 is a flow diagram showing a testing procedure for the exemplary implementation model simulation according to the present invention;

FIG. 11 illustrates a block diagram of the environment and configuration of an exemplary system 200 for incorporating the present invention; and

FIG. 12 illustrates a storage medium 300 for storing steps of the program for analyzing implementation models of business solutions.

### DETAILED DESCRIPTION OF EXEMPLARY EMBODIMENTS OF THE INVENTION

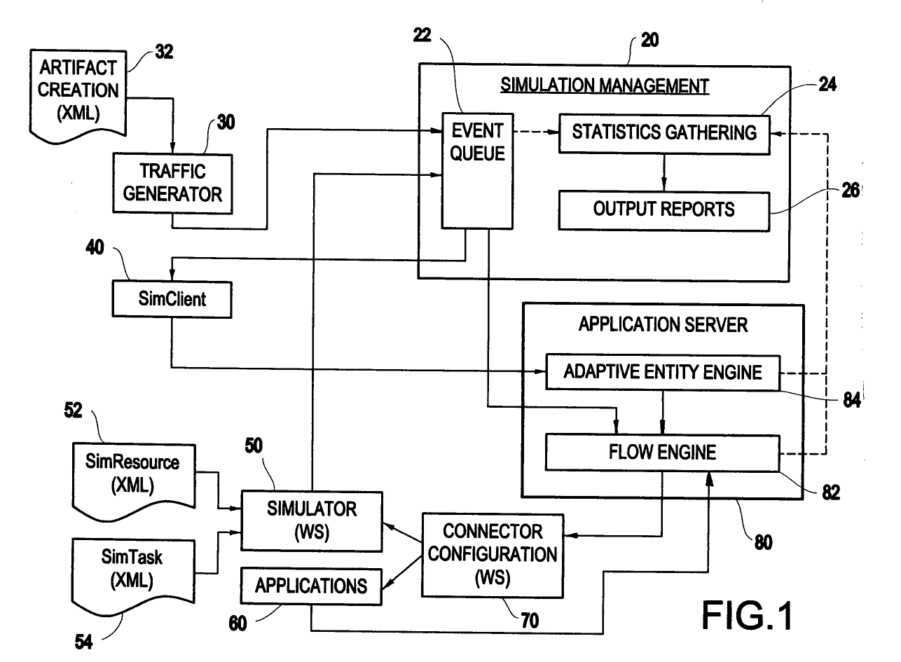

Referring now to the drawings, and more particularly to FIGS. 1-12, there are shown exemplary embodiments of the method and structures according to the present invention.

FIG. 1 illustrates a flow diagram showing a preferred embodiment of the invention in a method for simulating and analyzing implementation models for business solutions.

The phrase “simulating implementation models”, in accordance with the present invention, refers to analyzing an implementation model using both real solution components and simulated solution components to detect functional and nonfunctional defects in a business solution. The term “simulating” is not meant to limit the method of the present invention to solely using simlulated input data and solution components. The inventive method enables the analysis of an implementation model during all stages of the implementation model development and integration lifecycle, using simulated and real solution components.

FIG. 1 depcits the overall architecture for an implementation model simulation system 10 including a simulation management module 20 and a traffic generator 30, and how each of the individual components interact with each other.

The traffic generator 30 generates client orders according to instructions from an artifact creation configuration file 32. Each client order generated by the traffic generator 30 is assigned a submission date, and optionally at least one (and more specifically several) client order parameter. The parameters assigned to the client orders include information such as the client's name, specific item ordered, quanitity of items ordered, delivery instructions, etc. The details of these attributes will vary depending on the business solution. Once generated, the client orders are submitted to simulation management 20 where the orders are sorted based on their submission dates and are stored in an event queue 22.

The event queue 22 keeps track of the work flow through the implementation model by controlling the timing and invocation of events. There are several exemplary types of events associated with the implementation model simulation. A first type of event comprises the client orders that are generated by the traffic generator 30. The event queue 22 sends stored client orders to an application server 80 at scheduled times based on the submission date of the client orders.

The event queue 22 instructs a simulated client, (e.g., SimClient) 40, to send the client orders to an adaptive entity engine 84 of the application server 80. The adaptive entity engine 84 is a state machine with state transition logic. State transition logic is externaly editable, and thus the adaptive entity engine 84 makes it possible to easily combine multiple data flows and alter the logic based on the multiple data flows.

In addition, the adaptive entity engine 84 provides a function of scheduling a timeout event which is automatically invoked if no transition event is fired before a specified time duration. This function allows functional defects in an application to be detected as they occur. The adaptive entity engine 84 is described in pending U.S. Patent Application No. 20030187743A1 (“Method and System for Process Brokering and Content Integration for Collaborative Business Process Management), filed on Feb. 2, 2002, and is incorporated herein by reference.

As mentioned above, the adaptive entity engine 84 is an optional feature of the present invention, and thus present invention can be implemented without the adaptive entity engine 84. The application server 80 also comprises a flow engine 82. The flow engine 82 can also provide the function of scheduling a timeout event and can also combine multiple flows of data. Thus, client orders may be sent directly to the flow engine 82 from the SimClient 40.

The flow engine 82 allows a user of the implementation model simulation method 10 to flexibly combine a multitude of software assets.

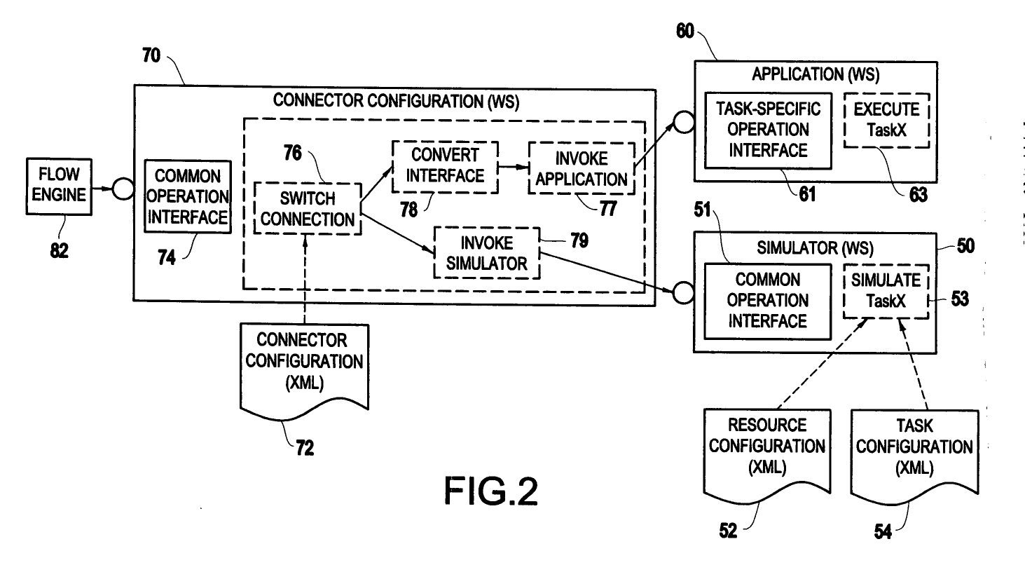

Conventionally, a flow engine directly invokes real applications by turns according to control flow definitions. In the architecture of the present implementation model simulation method 10 (and as shown in greater detail in FIG. 2), however, the flow engine 82 invokes a connector configuration webservice 70 instead of various real applications. The flow engine 82 sends information defining applications to be invoked as parameters to the connector configuration webservice 70.

The connector configuration webservice 70 controls the type of solution component that is invoked through the implementation model. As stated above, the implementation model simulation method 10 of the present invention uses both real solution components and simulated solution components. The connector configuration webservice 70 switches between real solution components (or applications) 60 and simulated solution components 50 according to the instructions of a connector configuration file 72 (FIG. 2).

Thus, if several new solution components are set up, the user can easily switch from simulated solution components to real solution components by editing the connector configuration file 72. By providing the connector configuration webservice 70, the flow engine 82 does not need to know if the component which the flow engine 82 has invoked is a real solution component or a simulated solution component. The flow engine 82, therefore, does not need to change the work flow. The work flow will continue at all stages of the development and integration lifecycle. All changes in the work flow occur at the connector configuration webservice 70.

A second type of event controlled by the event queue 22 comprises response events. Response events may be sent from a simulator 50, to the flow engine 82 of the application server 80 through the event queue 22. The simulator response events may include simulated output business objects of an application, delay time, etc. Simulated output business objects include client order parameters such as the client's name, components of a product, availability of a product, etc. Delay time refers to the time elapsed from when the simulator is invoked and when the flow engine receives a response. After the delay time, the event queue 22 sends the output business object back to the flow engine 82.

In the architecture for implementation model simulation system 10 of the present invention, a single simulator webservice 50 simulates solution components for a plurality of types of business solution applications (or tasks). Based on simulator configuration files 52, 54 that store behaviors of applications and resources, the simulator webservice 50 consumes simulated resources, calculates delay time and generates response business objects. This simulated data is transferred to the event queue 22, where response events including delay time and response business objects are stored. Because the simulator functions independent of any specific business solution application, new components to be simulated can be easily added to the implementation model simulation system 10.

Real business solution components or real applications are stored in and provided by the applications webservice 60. Based on the connector configuration file 72, the connector configuration webservice 70 switches between real applications and simulated solution components. While the response events from the simulator webservice 50 are sent to the flow engine 82, through the event queue 22, real response business objects are sent directly from the applications webservice 60 to the flow engine 82, as instructed by the connector configuration webservice 70.

In addition to the event queue 22, simulation management 20 also comprises statistics gathering 24 and output reporting 26. Once the simulation of the implementation model is complete, statistics gathering 24 gathers simulation results from the event queue 22 and the flow engine 82. The gathered statistics are partly similar to that available from traditional business process simulation (see for example, WBI Workbench V4.2.3).

More specifically, the statistics gathering 24 includes tables describing client order statistics (such as arrival time, completion, cycle times, processing costs, waiting time, etc.), resource statistics (utilization %, total cost, etc.), and queue statistics for each task (average queue size, average queue waiting time, maximum queue size, etc.). The gathered statistics are provided to the user in output reports 26. The statistics gathering 24 also identifies whether an invoked activity has been completed or not.

FIG. 2 is a flow diagram illustrating the role of the connector configuration webservice 70 in the exemplary implementation model simulation method 10 of the present invention. The flow engine 82 invokes each task in the implementation model through the connector configuration webservice 70. As stated above, the connector configuration webservice 70 switches between the application webservice 60 and the simulator webservice 50.

If an invoked task is connected to the simulator webservice 50, then a switch connector 76 of the connector configuration webservice 70 simply invokes the simulator webservice, as shown by reference 79, and forwards the input business object to the simulator webservice 50. The connector configuration webservice 70 can simply forward the input business object to the simulator webservice 50 because the simulator 50 shares a common interface 51 with the connector configuration 70.

The simulator 50 then generates a response business object and sends the response business object back to the flow engine 82. The response business object is generated based on resource configuration files 52 and task configuration files 54.

On the other hand, if an invoked task is an application 60, the switch connection 76 of the connector configuration webservice 70 invokes a real application 77 by converting the interface 77 to a task-specific interface 61, by using a stub that is dynamically generated at a first-time invocation by referring to a web service description language (WSDL) file of the application webservice 60.

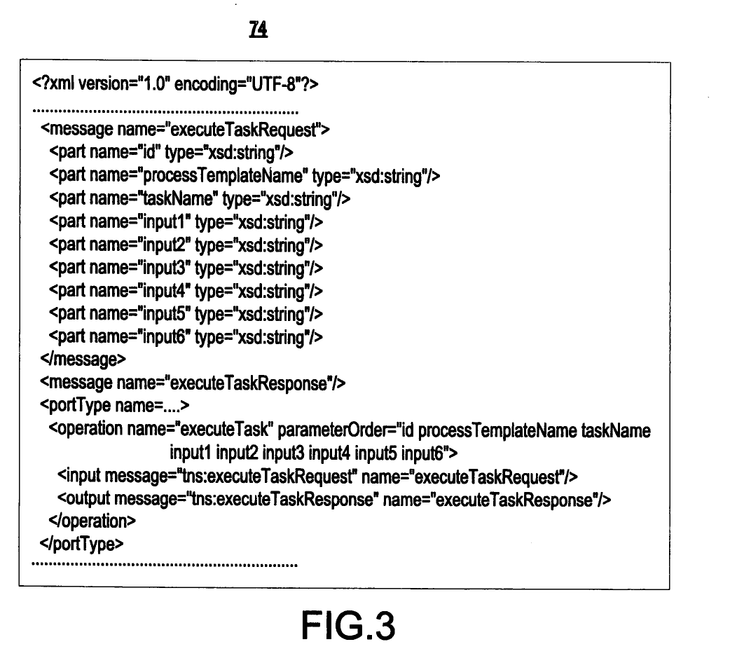

The connector configuration webservice 70 provides the flow engine with a single common operation interface 74 which contains code (FIG. 3) including the name of the task to be invoked and information of the input business object. Based on this information, the connector configuration webservice 70 converts the common interface 74 to a task specific interface 61 and then executes each application 60.

It is noted that all task specific items are externalized as editable configuration files, so that new components can be easily added to the system. As shown in FIG. 2, the externalized configuration files 72, 52, 54 comprise an XML programming language. However, the configuration files are not limited to XML and may use any mark-up programming language, any object oriented program such as JAVA® or any other format, including text, etc.

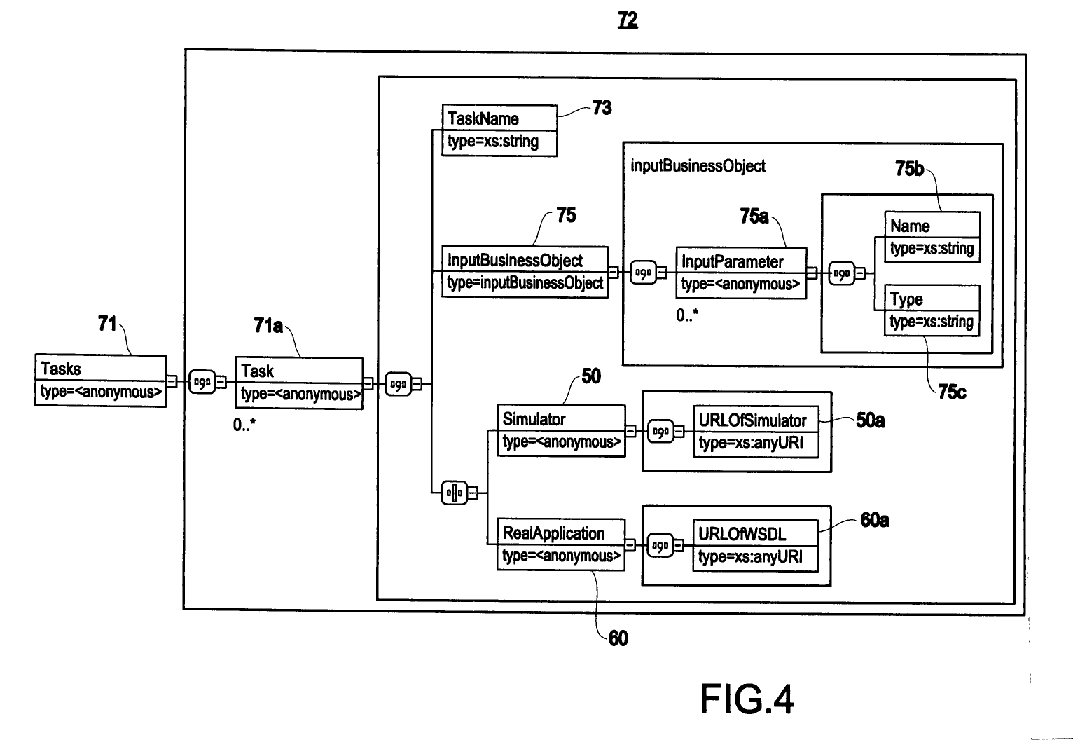

The connector configuration webservice configuration file 72 is illustrated in further detail in FIG. 4. The connector configuration webservice configuration file 72 determines whether a task 71a corresponds to the application webservice 60 or the simulator webservice 50. The connector configuration webservice configuration file 72 provides information including the task name 73 and input parameters 75a (including the name 75b and type 75c of input business object 75) of the input business objects 75, for each individual task 71a. The connector configuration webservice configuration file 72 also provides the connector configuration webservice 70 with the URL of the simulator webservice 50a and the URL of the WSDL file of the applications webservice 60a so that the connector configuration webservice 70 may switch between the simulator webservice 50 and the applications webservice 60.

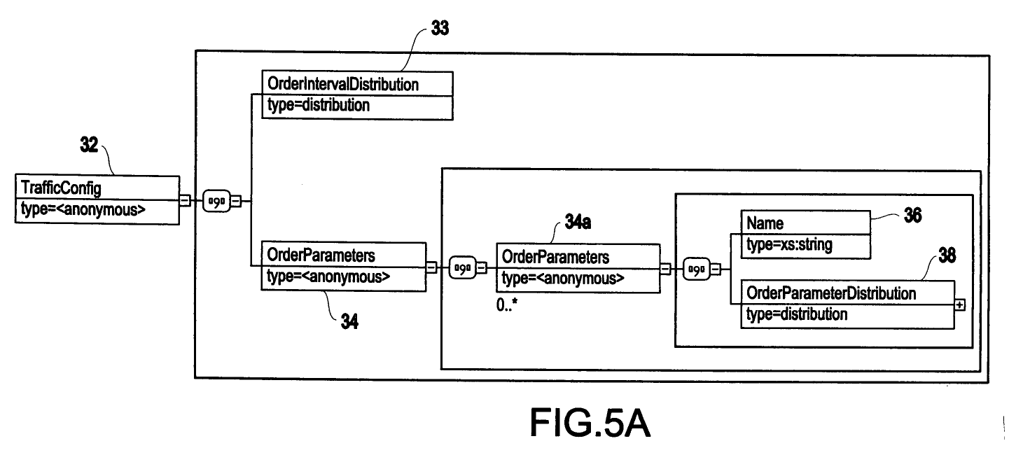

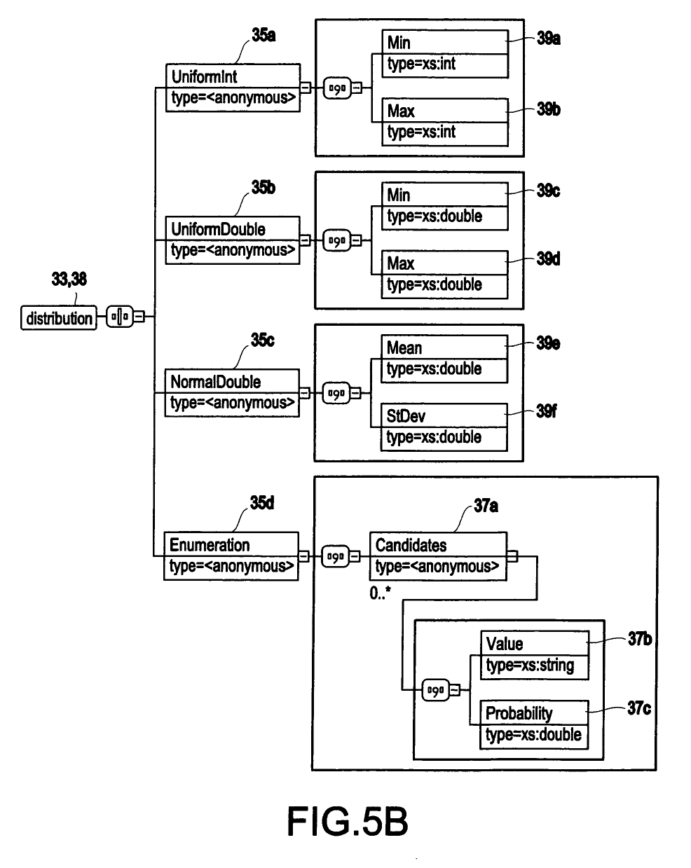

FIGS. 5A and 5B are schematic diagrams illustrating a schema of a configuration file 32 for generating traffic data of the implementation model simulation method 10 of the present invention. The traffic generator 30 generates simulated client orders based on an artifact creation configuration file 32 (or traffic configuration file). The traffic configuration file 32 describes a distribution of order intervals 33 and information parameters 34 of client orders. The distributiuon of order intervals 33 includes, for instance, data of the average number of customers placing orders during specific time intervals. Each individual client order parameter 34a includes information such as the name of the client 36 and distributions describing different order parameters 38.

FIG. 5B illustrates the schema for generating distributions that describe different random variables such as order parameters 38. UniformInt 35a refers to a random distribution of integers which is uniformly distributed between two values, minimum (Min) 39a and maxium (Max) 39b. UniformDouble 35b refers to a random distribution of real numbers which is uniformly distributed between two values, minimum (Min) 39c and maximum (Max) 39d. NormalDouble 35c refers to a normal (or bell curve) distribution with a mean (Mean) 39e and standard deviation (StDev) 39f. Enumeration 35d refers to a distribution where one of Candidates 37a is selected with Probability 37c. This invention is by no means limited by these distributions and any other type of distribution can be utilized in the distribution 33.

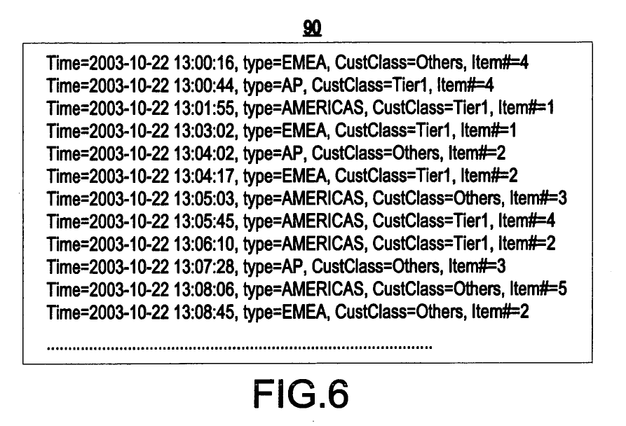

FIG. 6 is a diagram illustrating sample simulation input data 90. Simulation input data 90 is stored in the event queue 22 until the event queue 22 instructs the SimClient 40 to send a simulated client order to the flow engine 82 at each scheduled submission date in the client order. With each submission of a client order, the flow engine 82 generates a process instance. The process instance invokes specific process tasks.

A process instance includes a specific process for achieving a client order. This process could, in turn, consist of several activities and other sub-processes. For example, a client order is submitted having certain parameters. The order parameters may include the client's name, a description of the product ordered, a quantity of the product ordered and a shipping destination for the client order. The process instance aims to fulfill the client order. The specific tasks invoked by the process instance comprise locating the product, obtaining the desired quantity of the product ordered and delivering the product to the client.

As stated above, the simulator webservice 50 functions based on two separate configuration files (e.g., the simulated resource configuration file 52 and the simulated task configuration file 54).

Modeling resource behavior, or resource attributes, during simulation is mainly pertinent to identify the implications for resource utilizations, identify any resource bottlenecks and resulting resource costs. This information is used to infer the cost performance tradeoffs for the business solution.

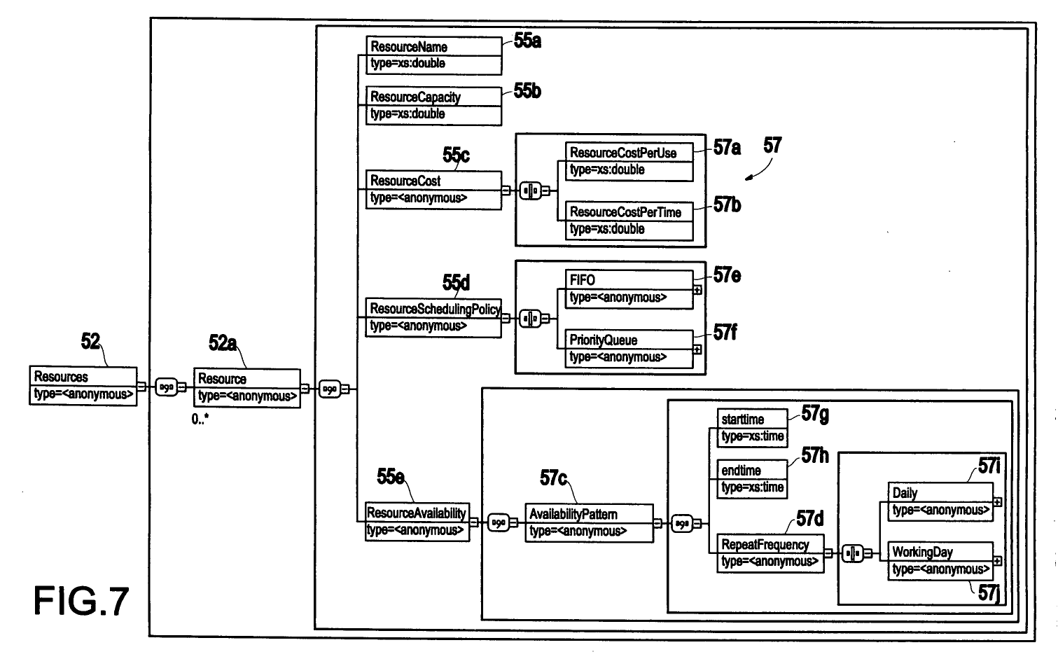

FIG. 7 illustrates the schema for the simulation resource configuration file 52. The schema of each of the simulation resource configuration files 52a exemplarily represents the parameters 57 required to simulate resource attributes 55 and utilization at a run time of the business solution implementation model. The resource attributes 55 may include the name of the resource 55a, the capacity of the resource 55b, the cost of the resource 55c, the resource scheduling policy 55d and the resource availability 55e. Certain resource attributes 55 are dependent on attribute parameters 57. For instance, the resouce cost 55c is determined based on resource cost per use 57a and resource cost per time 57b. The resource scheduling policy 55d is FIFO 57e or a priority queue 57f. FIFO refers to a scheduling policy of “First In First Out”. The resource availabiltiy 55e is based on an availability pattern 57c. The availability pattern 57c is used to model patterns of resource availability 55e, such as holidays, weekends, scheduled maintenance, etc. The repeat frequency 57d is used to specify the frequency at which the pattern repeats, such as weekly, daily 57i, working days 57j, etc. The start time 57g and the end time 57h determine the duration of the repeat frequency 57d by controlling when the start time and the end time of the repeat frequency 57d. This is only an illustrative schema and the invention is not limited by the specific attributes in this schema.

Modeling task behavior or attributes during simulation is pertinent to identify the implications for overall cycle time, queuing behavior, resulting delays, etc. This is also used to infer the cost performance tradeoffs for the business solution.

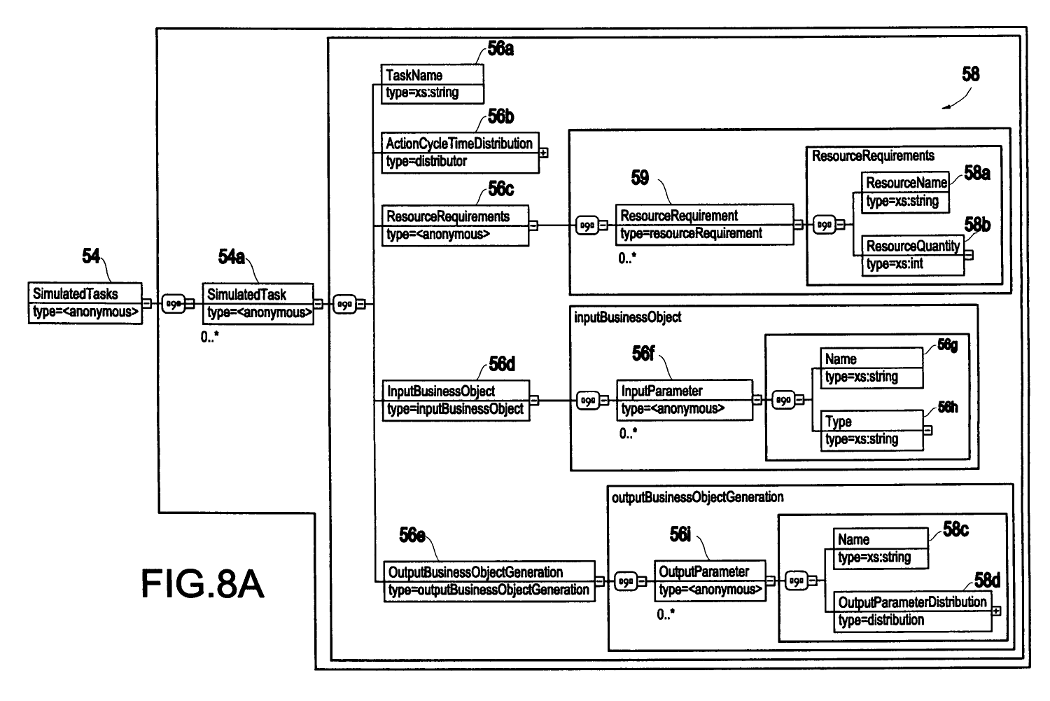

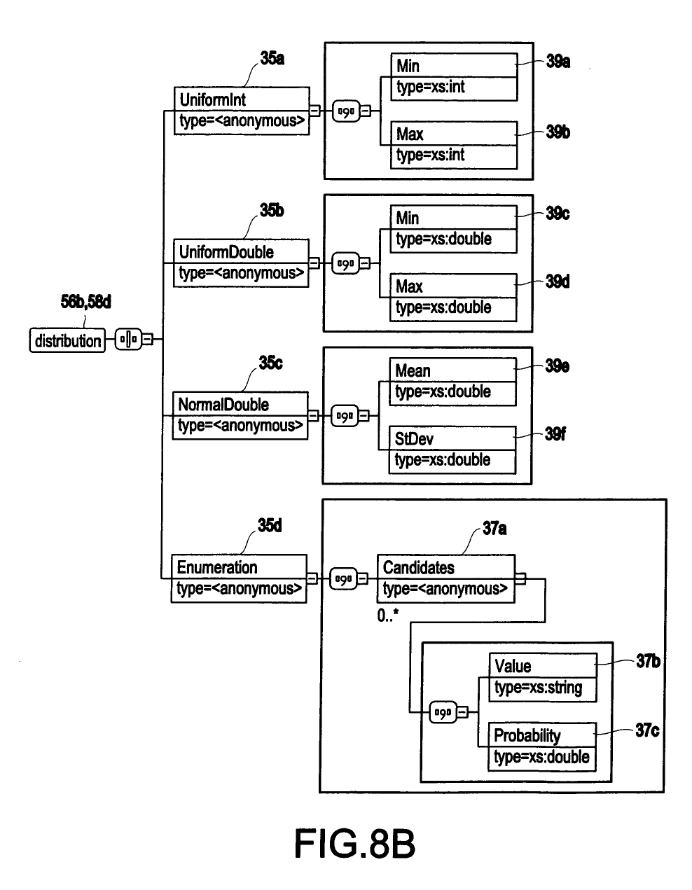

FIG. 8A illustrates the schema for the simulation task configuration file 54. The schema for the simulation task configuration file 54 represents the parameters 58 required to simulate task behavior or attributes 56 at run time, for each simulated task 54a. The task attributes 56 include the task name 56a, action cycle time distribution 56b, resource requirements 56c, input business objects 56d, and output business object generation 56e. Certain task attributes 56 are dependent on attribute parameters 58. The action cycle time distribution 56b describes the distribution of the time elasped during the execution of a task. The resource requirements 56c describe what resources 58a are required to complete the task and the quantity 58b of each resource is required. The input business object 56d includes input parameters 56f which describe the name 56g and type 56h of the input business object. The output business object generation 56e includes output parameters 56i which describe the output of the task and is based on the type of output parameter 58c and the distribution of the output parameter 58d.

FIG. 8B illustrates the schema for random numbers, such as the action cycle time distribution 56b and the output parameter distribution 58d. UniformInt 35a refers to a random distribution of integers which are uniformly distributed between two values—Min 39a and Max 39b. UniformDouble 35b refers to a random distribution of real numbers which are uniformly distributed between two values—Min 39c and Max 39d. NormalDouble 35c refers to a normal (or bell curve) distribution with mean Mean 39e and standard deviation StDev 39f. Enumeration 35d refers to a distribution where one of Candidates 37a is selected with Probability 37c. Any other type of distribution can be applied to the distributions 56b, 58d.

Unlike traditional simulation, the simulation method of the present invention involves both real components (e.g., flow-engine and tasks/entities) executed in real time and simulated components (e.g., client orders and tasks/entities) executed in virtual time. Therefore, simulated components should be synchronized to real time simulations involving real components. However, a complete real time simulation could take a prohibitively long time to be of practical utility. There are a plurality of methods of synchronizing the simulated solution components to the real solution components that do not require a considerable amount of time.

A first exemplary method of synchronizing the simulated solution components comprises compressing the intervals of the client orders. By polling the flow engine 82, it is possible to identify whether the flow engine 82 is executing any process instance or not. At any time, if there are no process-instances in the flow engine 82, intervals between client orders can be compressed. All of the correspondences between real time submission times and simulated times of submission of client orders are logged in the event queue 22. By using these logs, simulated statistics such as cycle time and resource utilization can be calculated from real statistics. Therefore, this compression operation does not affect simulation results.

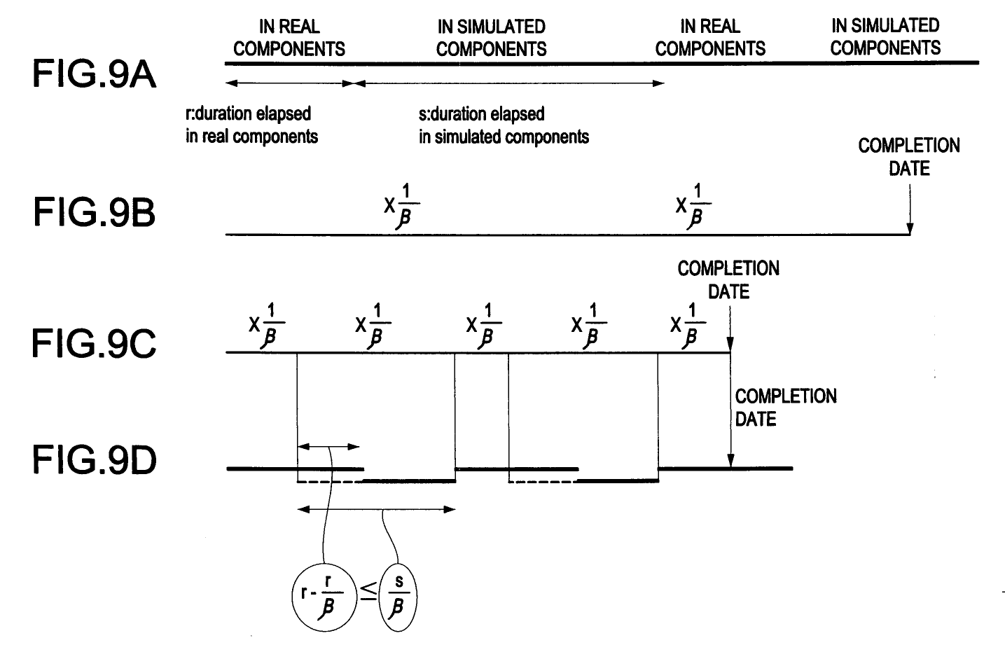

A second method of synchronizing the simulated solution components includes simulation fast forward. Simulation fast forward is executed by scaling delay times in the simulator webservice 50 and intervals of client orders. As FIG. 9A shows, in the proposed simulation environment, duration in real components and duration in simulated components occur by turns. Assume that r is equal to the duration elapsed in real components and s is equal to the duration elapsed in simulated components and β (≧1) is a scale factor for fast-forward simulation.

Note that though one can freely scale elapsed time in simulated components, one cannot control elapsed time in real components. If all elapsed times in real solution components and simulated solution components are fast-forwarded (FIG. 9C), then one can easily calculate simulated statistics of the system from real statistics. However, since elapsed times in only simulated components can be fast-forwarded (FIG. 9B), it is difficult to correctly calculate simulated statistics of the system from real statistics.

To handle this problem, the invention lets simulated components absorb a difference between fast-forwarded elapsed time (r/β) which cannot be applied to real components and their measurable normal elapsed time (r) (FIG. 9D). This difference is (r−r/β) and a fast-forwarded duration in the simulated solution components is (s/β). Therefore, if (r−r/β) is smaller than (s/β), then the difference can be absorbed in simulated components. From this condition, the maximum value of the scale factor which does not have an effect on simulation results can be determined as follows:

$$β \leq 1 + \frac{{s}_{min}}{{r}_{max}}$$

where sₘᵢₙ is a minimum duration elapsed in the simulated solution components and rₘₐₓ is a maximum duration elapsed in real solution components.

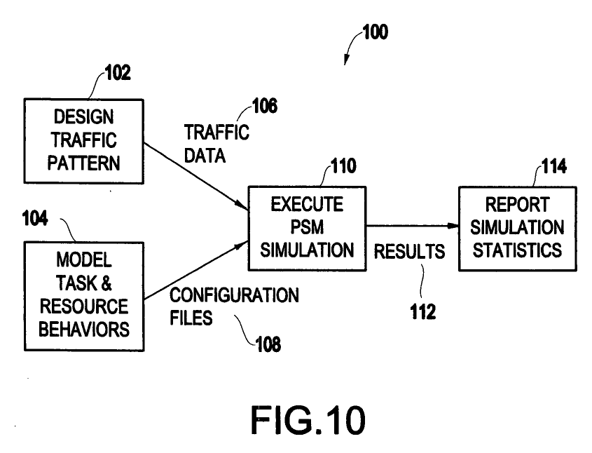

The simulation method of the present invention allows the user to execute a plurality of types of testing, including functional testing and performance testing. Functional testing is used for identifying locations of application failures if they happen. On the other hand, performance testing is used for providing estimates for hardware sizing and middleware configuration. Testing procedures 100 of the two types of testing are the same, as shown in FIG. 10.

First, a traffic pattern 102 to be inputted is designed. Second, behaviors of tasks and resources 104 are modeled and described in the corresponding configuration files 108. Then, the implementation model simulation method of the present invention is executed 110 using the simulated traffic pattern data 106 and the configuration files 108. After simulation, simulated results are reported to the user 114.

By detecting timeouts in flows, the locations of application failures can be identified. Table 1 shows sample statistics for a simulation done in the functional testing mode. Table 1 lists several client orders, and the arrival time and the completion time of each order. Table 1 also lists whether or not a defect was identified and if so, the cause of the defect, i.e., the state corresponding to the identified defect.

For instance, in BaseRequest1, the client order arrived on Jul. 1, 2003 at 8:00 and the order was completed on Jul. 1, 2003 at 11:30. Because the order was completed, no defect was detected, therefore no cause for a defect is listed for BaseRequest1.

Alternatively, in BaseRequest3, the client order was placed on Jul. 2, 2003 at 9:50 but the the client order was not completed. Thus, a timeout occured. In this example, the statistics suggest that there is a defect and that the defect has occurred in the logic for “Check Supply” flow.

TABLE 1
Job Statistics Table

| Customer | Arrival | Completion | State Corresponding |
|---|---|---|---|
| Order ID | Time | Time | to any Identified Problem |
| BaseRequest1 | Jul. 1, 2003 | Jul. 1, 2003 | N/A |
| | 8:00 | 11:30 | |
| BaseRequest2 | Jul. 1, 2003 | Jul. 2, 2003 | N/A |
| | 15:35 | 13:20 | |
| BaseRequest3 | Jul. 2, 2003 | N/A | Invoke Check Supply |
| | 9:50 | | |
| BaseRequest4 | Jul. 3, 2003 | Jul. 4, 2003 | N/A |
| | 17:00 | 10:45 | |
| BaseRequest5 | Jul. 4, 2003 | Jul. 4, 2003 | N/A |
| | 10:00 | 15:10 | |
| BaseRequest6 | Jul. 8, 2003 | Jul. 8, 2003 | N/A |
| | 1:30 | 16:45 | |
| BaseRequest7 | Jul. 10, 2003 | N/A | Invoke Check Supply |
| | 9:30 | | |
| BaseRequest8 | Jul. 10, 2003 | N/A | Invoke Check Supply |
| | 11:00 | | |
| BaseRequest9 | Jul. 11, 2003 | Jul. 11, 2003 | N/A |
| | 13:00 | 15:15 | |
| BaseRequest10 | Jul. 11, 2003 | Jul. 12, 2003 | N/A |
| | 14:00 | 16:00 | |

Under the performance testing mode, the gathered statistics are similar to that available from traditional business process simulation (for e.g. WBI Workbench V4.2.3). Table 1 describes customer order statistics (arrival, completion times) for checking whether the system meets the cycle time requirements. From the queue statistics of each task (average queue size, maximum queue size, average queue waiting time), listed in Table 2, locations of any existing bottlenecks can be identified. In addition, from resource statistics (utilization %, total cost, average waiting time), listed in Table 3, insights can be obtained for hardware sizing and middleware configuration.

TABLE 2
Queue Statistics Table

| | Max Queue | Average Queue | Average Wait Time |
|---|---|---|---|
| Task Name | Size | Size | (sec) |
| Customer Identity | 2 | 0.83 | 1.55 |
| Configuration | 2 | 1.13 | 2.43 |
| Availability Check | 4 | 2.54 | 6.13 |

TABLE 3
Resource Statistics Table

| | | | Average Wait Time |
|---|---|---|---|
| Resource Name | Utilization (%) | Total Cost ($) | (sec) |
| WCBE CPU | 35.5 | 12.5 | N/A |

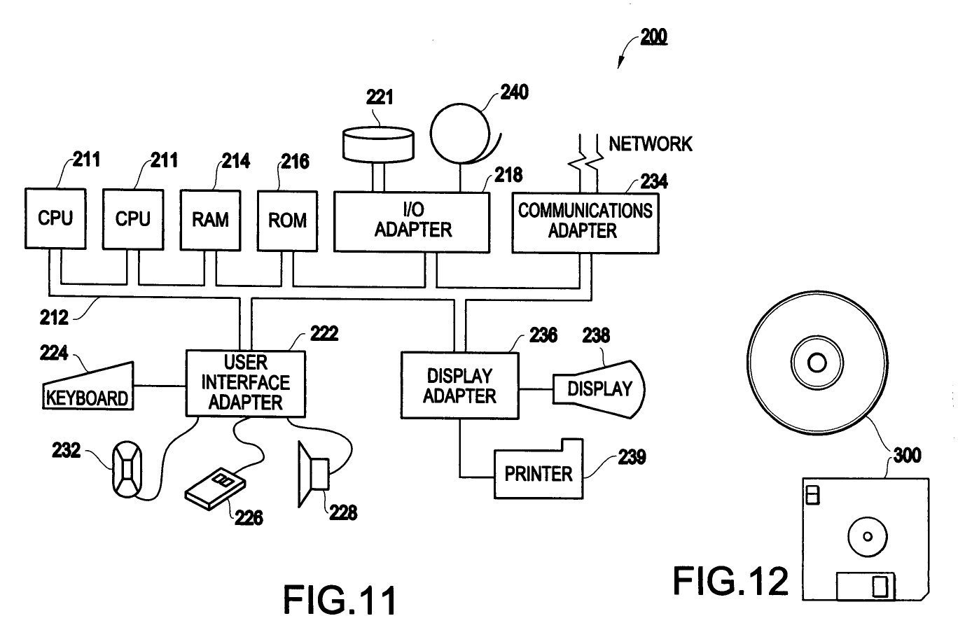

FIG. 11 shows a typical hardware configuration of an information handling/computer system in accordance with the invention that preferably has at least one processor or central processing unit (CPU) 211. The CPUs 211 are interconnected via a system bus 212 to a randon access memory (RAM) 214, read-only memory (ROM) 216, input/output adapter (I/O) 218 (for connecting peripheral devices such as disk units 221 and tape drives 240 to the bus 212), user interface adapter 222 (for connecting a keyboard 224, mouse 226, speaker 228, microphone 232, and/or other user interface devices to the bus 212), communication adapter 234 (for connecting an information handling system to a data processing network, the Internet, an Intranet, a personal area network (PAN), etc.), and a display adapter 236 for connecting the bus 212 to a display device 238 and/or printer 239 (e.g., a digital printer or the like).

As shown in FIG. 11, in addition to the hardware and process environment described above, a different aspect of the invention includes a computer implemented method of performing a method for simulating and analyzing implementation models of business solutions. As an example, this method may be implemented in the particular hardware environment discussed above.

Such a method may be implemented, for example, by operating a computer, as embodied by a digital data processing apparatus to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 211 and hardware above, to perform the method of the present invention.

This signal-bearing media may include, for example, a RAM (not shown) contained with the CPU 211, as represented by the fast-access storage, for example. Alternatively, the instructions may be contained in another signal-bearing media, such as a magnetic data storage diskette or CD diskette 300 (FIG. 12), directly or indirectly accessible by the CPU 211.

Whether contained in the diskette 300, the computer/CPU 211, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc,), or other suitable signal-bearing media including transmission media such as digital and analog and communication links and wireless. In an illustrative embodiment of the invention, the machine-readable instructions may comprise software object code, compiled from a language such as “C”, etc.

As discussed above in a preferred embodiment, the method and system for simulating implementation models of business solutions addresses the objectives of users in the field of integrating business solutions. By enabling the analysis of business processes during the development and deployment phases of the implementation model management lifecycle, the present invention provides a method of analyzing implementation models of solutions that reduces cost and time by eliminating the need for running multiple iterations during the design of a business solution. Furthermore, unlike conventional implementation models simulation methods, the present method and system for simulating implementation models of business solution allows the user to simulate implementation models of business solutions using both real solution components and simulated solution components.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method for simulating an implementation model of a business solution comprising:
simulating business artifacts that invoke the implementation model of the business solution;
at least one of simulating and executing a component of the business solution during at least one intermediate stage of a development and integration lifecycle of the implementation model; and
analyzing results from the simulation of the implementation model during said at least one intermediate stage of the development and integration lifecycle of the implementation model.

2. The method according to claim 1, wherein said analyzing the implementation model comprises:
generating a simulated business artifact; and
modeling a behavior of a solution component and storing said behavior of the solution component in a configuration file.

3. The method according to claim 2, further comprising:
executing the implementation model using said simulated business artifact and said configuration file.

4. The method according to claim 2, further comprising:
reporting simulated statistics of the implementation model.

5. The method according to claim 2, wherein said solution component comprises a real solution component and a simulated solution component.

6. The method according to claim 2, further comprising:
assigning a submission date and a business artifact parameter to each said simulated business artifact.

7. The method according to claim 2, further comprising:
combining multiple data flows and altering the simulation of said method based on said multiple data flows.

8. The method according to claim 2, further comprising:
scheduling a timeout event if no response event from a real application occurs before a specified time duration.

9. The method according to claim 8, wherein said timeout event is invoked automatically if no response event from a real application occurs before said specified time duration.

10. The method according to claim 5, wherein a connector configuration switches between said real solution component and said simulated solution component based on an instruction from said configuration file.

11. The method according to claim 2, further comprising:
simulating a plurality of solution components for a plurality of types of business solution tasks independent of any specific business solution task.

12. The method according to claim 10, wherein said connector configuration includes a common interface for said real solution component and said simulated solution component.

13. The method according to claim 3, further comprising:
synchronizing said real solution component and said simulated solution component.

14. The method according to claim 13, wherein said synchronizing said real solution component and said simulated solution component comprises compressing an interval between business artifacts that trigger the business solution.

15. The method according to claim 13, wherein said synchronizing said real solution component and said simulated solution component comprises scaling a delay time during simulation of a solution component and a scaling interval between business artifacts that trigger the business solution.

16. The method according to claim 2, further comprising:
functionally testing the implemention model to identify a location of a defect as the defect occurs.

17. The method according to claim 2, further comprising:
performance testing the implementation model to provide an estimate for hardware sizing and middleware configuration.

18. The method according to claim according to claim 2, further comprising:
tracking a work flow of said simulated business artifact by controlling a timing and an invocation of a client order event.

19. The method according to claim 6, further comprising:
sorting said simulated business artifact based on said submission date; and
storing said simulated business artifact.

20. The method according to claim 2, further comprising:
identifying a defect at said intermediate stage of the development and integration lifecycle to prevent said defect from propogating through said development and integration lifecycle.

21. A computer system for simulating an implementation model of a business solution, comprising:
means for implementing an implementation model;
means for analyzing the implementation model during at least one intermediate stage of the development and integration lifecycle of the implementation model; and
means for communicating a result of said analyzing the implementation model.

22. A signal-bearing medium tangibly embodying a program of machine readable instructions executable by a digital processing apparatus to perform a method for analyzing an implementation model of a business solution, said method comprising:
implementing an implementation model; and
analyzing the implementation model during at least one intermediate stage of the development and integration lifecycle of the implementation model.

23. A method for deploying computing infracstructure, comprising integrating computer-readable code into a computing system, wherein the computer readable code in combination with the computing system is capable of performing a method for analyzing implementation models of a business solution, said method for analyzing an implementation model of a business solution comprising:
implementing an implementation model; and
analyzing the implementation model during at least one intermediate stage of the development and integration lifecycle of the implementation model.

24. An apparatus for simulating implementation models of a business solution, comprising:
a traffic generator that generates a business artifact;
a simulation manager that models a behavior of a solution component and stores the behavior of the solution component in a configuration file; and
a connector configuration that switches between a real solution component and a simulated solution component based on an instruction from the configuration file.

25. The apparatus according to claim 24, wherein said simulation manager manages the simulation execution including queue management, statistics gathering and output reporting.

26. The apparatus according to claim 24, wherein said business artifact comprises a client order.
